(19) United States
(12) Patent Application Publication
(10) Pub. No.: US 2007/0263326 A1
(43) Pub. Date: Nov. 15, 2007

(54) Apparatus and method for including amplification of read signal in slider of a hard disk drive

(75) Inventors: Brian D. Strom, Cupertino, CA (US); Na Young Kim, San Jose, CA (US); SungChang Lee, San Jose, CA (US); Vinod Sharma, Los Gatos, CA (US); Joseph Chang, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS, CO., LTD.

(21) Appl. No.: 11/434,607

(22) Filed: May 15, 2006

(51) Int. Cl. G11B 21/24

(52) U.S. Cl. 360/294.4

(57) ABSTRACT

A slider used to access data on a rotating disk in a hared disk drive, including a read-write head providing a read differential signal pair to an amplifier to generate an amplified read signal reported when read accessing a rotating disk surface near the slider, which includes a read head employing a spin valve or employing a tunneling valve. The amplifier may be bonded to the read-write head and/or built on the read-write head. Head gimbal assembly including the slider and further including micro-actuator assembly preferably sharing at least one power signal. Hard disk drive including a head stack assembly, which includes at least one of the head gimbal assemblies. Manufacturing the slider, the head gimbal assembly, the head stack assembly, and the hard disk drive, as well as these items as products of the invention's manufacturing processes.

### TECHNICAL FIELD

This invention relates to hard disk drives, in particular, to apparatus and methods for inclusion of amplification of the read signal in the slider of a hard disk drive.

### BACKGROUND OF THE INVENTION

Contemporary hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known herein as track following. It is during track following mode that the read-write head is used to access the data stored of the track.

Micro-actuators provide a second actuation stage for lateral positioning the read-write head during track following mode. They often use an electrostatic effect and/or a piezoelectric effect to rapidly make fine position changes. They have doubled the bandwidth of servo controllers and are believed essential for high capacity hard disk drives from hereon.

A central feature of the hard disk drive industry is its quest for greater data storage density, leading to continued reduction in track width, and the size of the read head within the read-write head. As the read head shrinks, the read signal it can generate will grow weaker. While contemporary hard disk drives have a preamplifier located in the actuator assembly, this weak read signal must travel a path from the slider with significant resistance before it can be amplified. What is needed is a mechanism strengthening the read signal before it leaves the slider.

### SUMMARY OF THE INVENTION

The invention includes a slider used to access data on a rotating disk in a hared disk drive. The slider includes a read-write head providing a read differential signal pair to an amplifier to generate an amplified read signal reported when read accessing a rotating disk surface near the slider. The read-write head may include a read head employing a spin valve or employing a tunneling valve. The amplifier may be bonded to the read-write head and/or built on the read-write head.

The invention includes a head gimbal assembly including the slider, and further including a micro-actuator assembly. The micro-actuator assembly and the slider may preferably share at least one power signal.

The invention includes a hard disk drive including a head stack assembly, which includes at least one of the head gimbal assemblies.

The invention includes manufacturing the slider, the head gimbal assembly, the head stack assembly, and the hard disk drive, as well as these items as products of the invention's manufacturing processes.

### BRIEF DESCRIPTION OF THE DRAWINGS

FIG. 1A shows a simplified schematics of the invention's hard disk drive and slider;

FIG. 1B shows an example of the read head of FIG. 1A employing a spin valve;

FIG. 1C shows an example of the read head of FIG. 1A employing a tunnel valve;

FIGS. 2A and 2B show examples of details of FIG. 1A;

FIGS. 2C and 2D show some details of the operation of the tunnel valve of FIG. 1C;

FIG. 2E shows a typical polarization of bits in the track on the rotating disk surface used with the spin valve of FIG. 1B;

FIG. 2F shows a typical polarization of bits in the track on the rotating disk surface used with the tunneling valve of FIG. 1C;

FIG. 3A shows a partially assembled hard disk drive of FIG. 1A;

FIG. 3B shows a head gimbal assembly including the slider of FIG. 1A coupled with a micro-actuator assembly using the piezoelectric effect;

FIGS. 4A and 4B show some details of the head gimbal assembly including the invention's slider;

FIGS. 5 to 7 show some details of the hard disk drive of FIGS. 1A and 3A;

FIG. 8A shows some details of the read-write head using the spin valve of FIG. 1B;

FIGS. 8B to 8D show some details of the invention's slider employing the spin valve of FIGS. 1B and 8A or the tunneling valve of FIGS. 1C, 9A, and 9B;

FIGS. 9A and 9B show some details of the read-write head employing the tunnel valve;

FIGS. 10A and 10B show some examples of the use of the piezoelectric effect in the micro-actuator assembly of FIG. 3B; and

FIGS. 11A and 11B show an example of the use of the electrostatic effect in a micro-actuator assembly for the head gimbal assembly of FIG. 4A.

### DETAILED DESCRIPTION

This invention relates to hard disk drives, in particular, to apparatus and methods for amplification of the read signal in the slider of a hard disk drive. In particular, a slider including a read-write head providing a read-differential signal pair to an amplifier to generate an amplified read signal, when the slider is used to read access data on a rotating disk surface in a hard disk drive. The slider reports the amplified read signal as a result of the read access of the data.

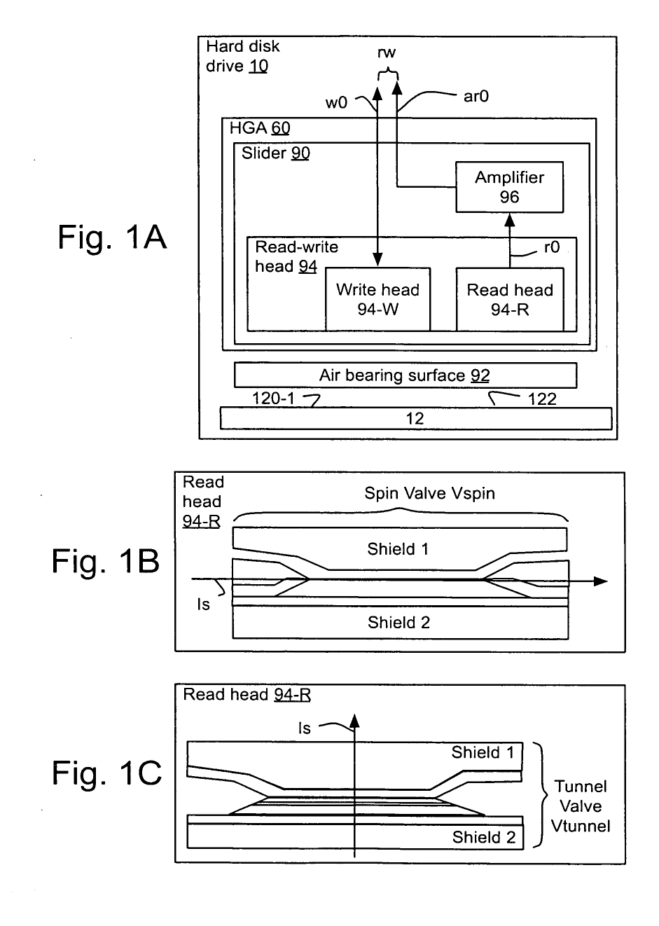

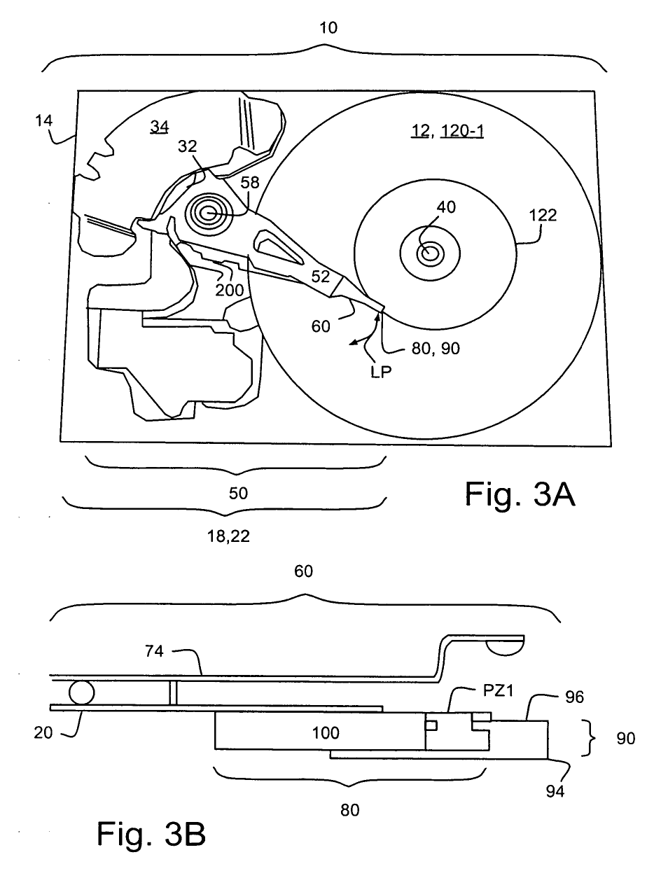

In greater detail, the invention's slider 90 includes the read-write head 94 providing the read-differential signal pair r0 to the amplifier 96 to generate the amplified read signal ar0, as shown in FIG. 1A. The read-write head preferably includes a read head 94-R driving the read differential signal pair r0 and a write head 94-W receiving a write differential signal pair w0. The slider is used to access the data 122 on the rotating disk surface 120-1 in a hard disk drive 10, as shown in FIG. 3A. The data is typically organized in units known as a track 122, which are usually arranged in concentric circles on the rotating disk surface centered about a spindle shaft 40. Operating the slider to read access the data on the rotating disk surface includes the read head driving the read differential signal pair to read access the data on the rotating disk surface, and the amplifier receiving the read differential signal pair to create the amplifier read signal. The slider reports the amplified read signal as a result of read access of the data on the rotating disk surface.

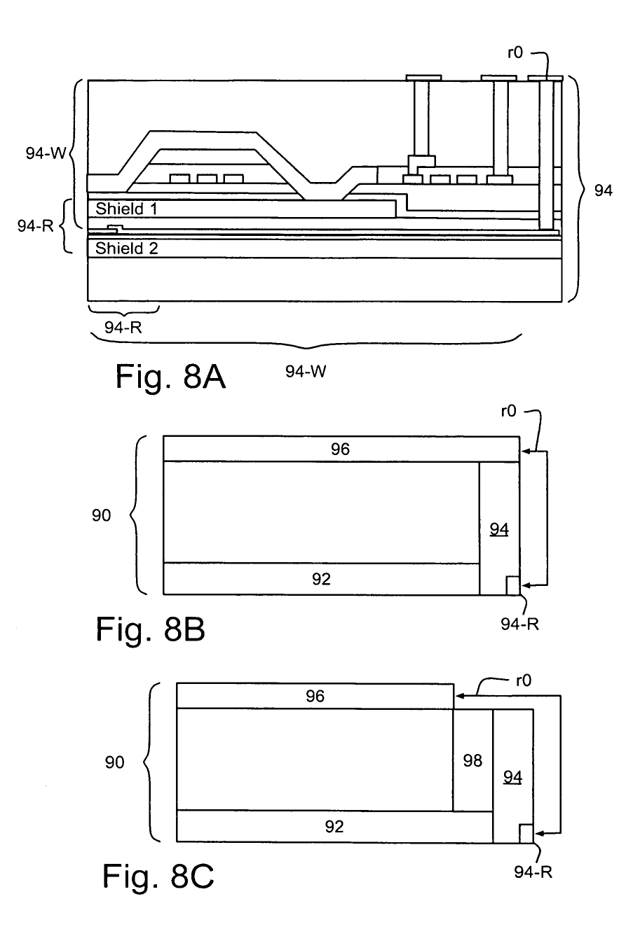

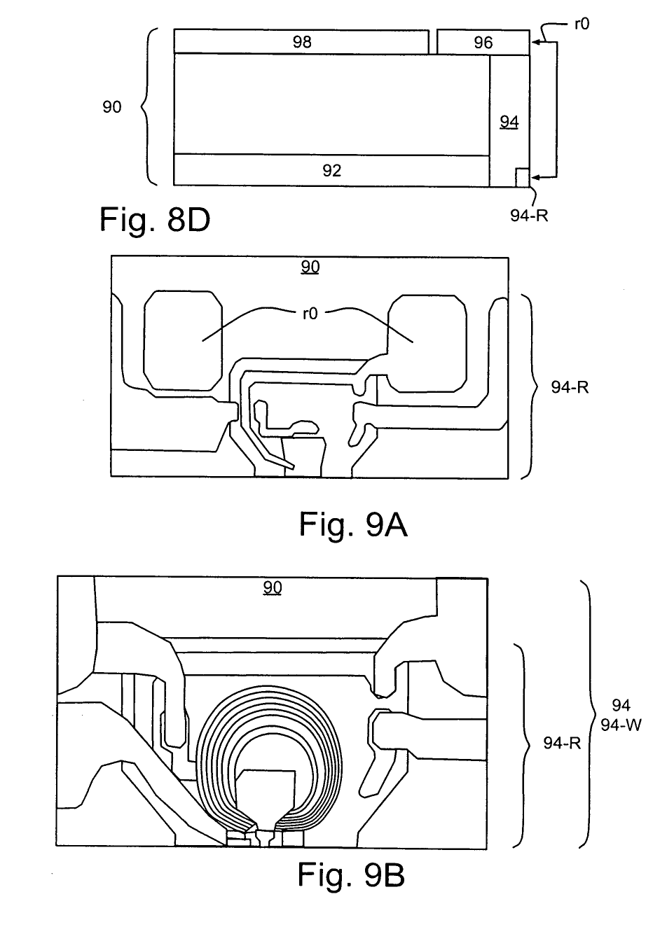

The read head 94-R of FIG. 1A may use a spin valve to drive the read differential signal pair as shown in FIG. 1B. As used herein, the spin valve employs a magneto-resistive effect to create an induced sensing current Is between the first shield Shield1 and the second shield Shield2. Spin valves have been in use the since the mid 1990's. An idealized, and simplified cross section of a read-write head using a spin vale is shown in FIG. 8A. FIG. 8B shows a simplified cross section of the invention's slider 90. The read-write head 94 traverses perpendicular to the air bearing surface 92 to the amplifier 96, due to the sensing current flowing between the shields.

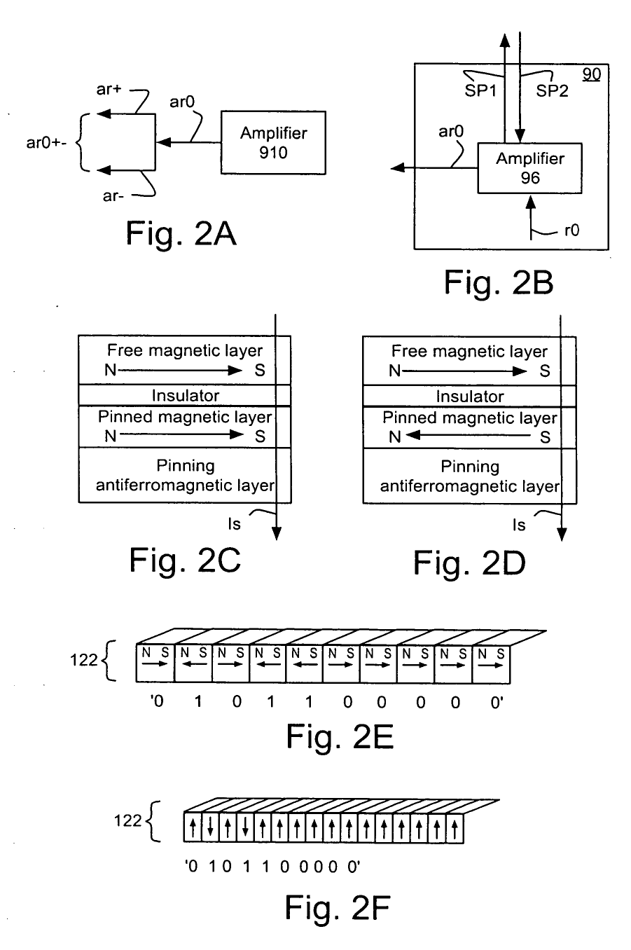

The read head 94-R may use a tunnel valve to drive the read differential signal pair as shown in FIG. 1C. As used herein, a tunnel valve uses a tunneling effect to modulate the sensing current Is perpendicular to the first shield Shield1 and the second shield Shield2. Both longitudinally recorded signals as shown in FIG. 2E and perpendicularly recorded signals shown in FIG. 2F can be read by either reader type. Perpendicular versus longitudinal recording relates to the technology of the writer/media pair, not just the reader. This difference in bit polarization lead to the announcement of a large increase in data density, a jump of almost two hundred percent in the spring of 2005.

To further discuss the tunnel valve and its use in embodiments of the invention, consider FIGS. 2C and 2D. The pinned magnetic layer is separated from the free ferromagnetic layer by an insulator, and is coupled to the pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the rotating disk surface 120-1, results in a change of electrical resistance through the tunnel valve. FIG. 2C shows the response with low resistance and FIG. 2D shows the high resistance response.

The position of the read head 94-R relative to air bearing surface 92 is the typically same for readers using either spin valves or tunneling valves. Both FIG. 1B and FIG. 1C show the view from the air bearing surface. In most but not all of the embodiments of the invention's slider 90, the amplifier 96 is preferably opposite the air bearing surface, as further shown in FIGS. 8B to 8D.

The amplified read signal ar0 may be implemented as an amplified read signal pair ar0+−as shown in FIG. 2A, or as a single ended read signal, as shown elsewhere throughout the FIGS. While the decision has been made to show the amplified read signal as a single ended read signal, this has been done to simplify the discussion, and is not intended to limit the scope of the invention.

The invention's slider 90 may further include a first slider power terminal SP1 and a second slider power terminal SP2 collectively used to power the amplifier 96 in generating the amplified read signal ar0, as shown in FIG. 2B.

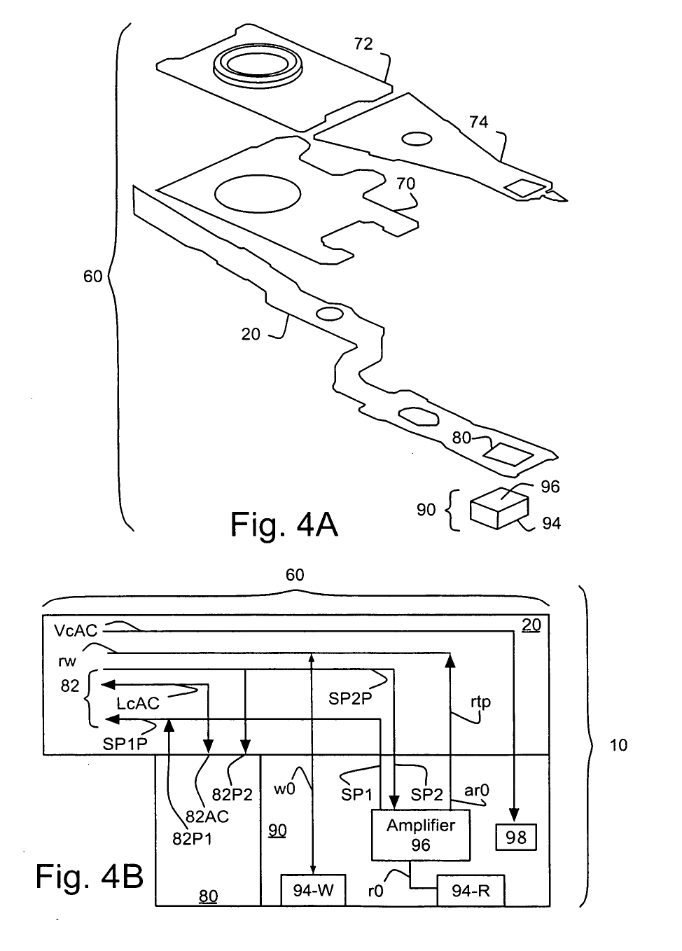

The slider 90 may also include a vertical micro-actuator 98 for urging the outermost portions of the read-write head 94 closer or farther away from the rotating disk surface 120 as shown in FIGS. 4B, 8C and 8D. The vertical micro-actuator may be a thermal actuator controlled by two electrical terminals, one of which may preferably be shared with SP1 The other terminal may preferably be connected to the vertical control signal VcAC, which may prefer an embodiment as shown in FIG. 8C. Other forms of the vertical micro-actuator mounted to the slider may be preferable, for example a piezoelectric actuator as shown in FIG. 8D. When a vertical micro-actuator is included in the slider, it tends to induce a strain on the materials directly coupled to it, making it preferable for the amplifier 96 to not be directly coupled to the vertical micro-actuator. Today's read-write head has five wires: two providing a differential read signal pair r0, two providing a write differential signal pair w0, and one signal providing the vertical control signal VcAC. The vertical micro-actuator may preferably be grounded to the load beam 74 through a via in the flexure finger 20 coupled to the load beam.

Manufacturing the invention's slider 90 includes coupling the read-write head 94 to the amplifier 96, which further includes electrically coupling the read differential signal pair to the amplifier. The invention includes the manufacturing process of the slider and the slider as a product of that manufacturing process. The manufacturing further includes providing an air bearing surface 92 near the read head 94-R, an in some embodiments, further providing the vertical micro-actuator 98.

Coupling the read-write head 94 to the amplifier 96 may further include bonding the amplifier to the read head 94-R and/or building the amplifier to the read head. Bonding the amplifier may include gluing, and/or welding, and/or soldering the amplifier to the read head. Building the amplifier may include depositing an insulator to create a signal conditioning base, and/or using a slider substrate as a signal conditioning base, and/or depositing a first semiconductor layer on the signal conditioning base. The building may further include define at least one pattern, at least one etch of the pattern to create at least one layer, for at least one semiconducting material and at least one layer of metal to form at least one transistor circuit embodying the amplifier. The transistors preferably in use at the time of the invention include, but are not limited to, bipolar transistors, Field Effect Transistors (FETs), and amorphous transistors.

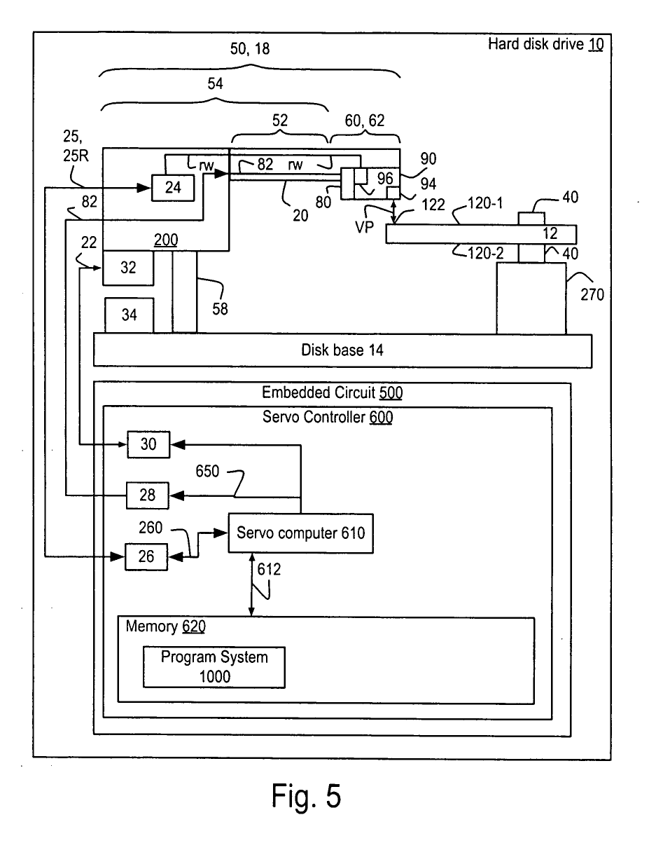

The invention includes a flexure finger 20 for the slider 90, providing a read trace path rtp for the amplified read signal ar0, as shown in FIG. 4B. The lateral control signal 82 preferably includes the first lateral control signal 82P1 and the second lateral control signal 82P2, as well as the AC lateral control signal 82AC. The flexure finger may further include a micro-actuator assembly 80 for mechanically coupling with the slider to aid in positioning the slider to access the data 122 on the rotating disk surface 120-1. The micro-actuator assembly may aid in laterally positioning LP the slider to the rotating disk surface 120-1 as shown in FIG. 3A and/or aid in vertically positioning VP the slider as shown in FIG. 5.

The micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. In several embodiments of the invention the micro-actuator assembly may preferably couple with the head gimbal assembly 60 through the flexure finger 20, as shown in FIGS. 3B and 4A. The micro-actuator assembly may further couple through the flexure finger to a load beam 74 to the head gimbal assembly and consequently to the head stack assembly 50.

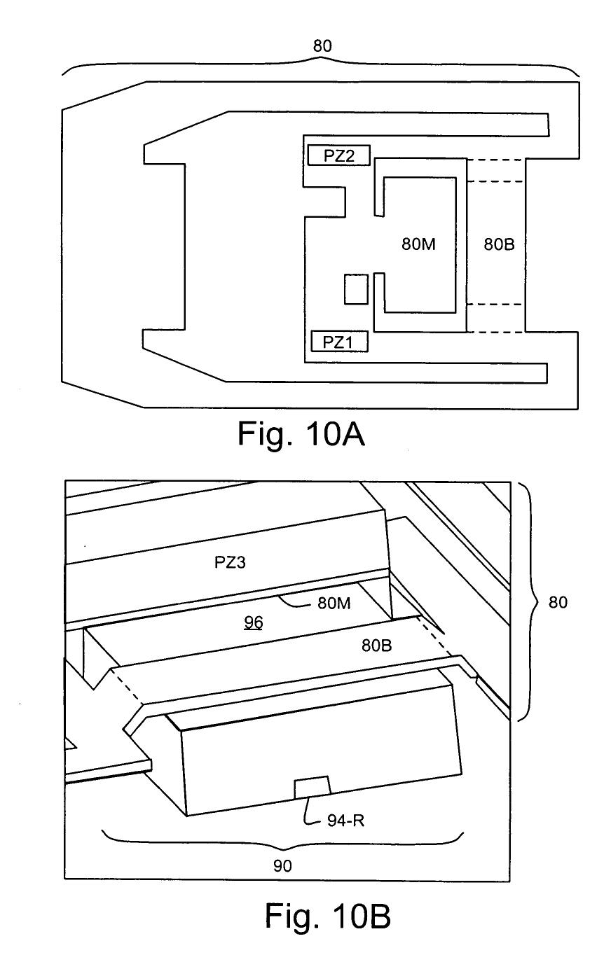

Examples of micro-actuator assemblies employing the piezoelectric effect are shown in FIGS. 3B, 10A and 10B. FIG. 3B shows a side view of a head gimbal assembly with a micro-actuator assembly 80 including at least one piezoelectric element PZ1 for aiding in laterally positioning LP of the slider 90. In certain embodiments, the micro-actuator assembly may consist of one piezoelectric element. FIG. 10B shows a micro-actuator assembly including the first piezoelectric element and a second piezoelectric element PZ2, which may preferably both aid in laterally positioning the slider. FIG. 10B shows a front perspective view of the micro-actuator assembly coupled with the slider with a third piezoelectric element PZ3 to aid in the vertically positioning the slider to the rotating disk surface 120-1.

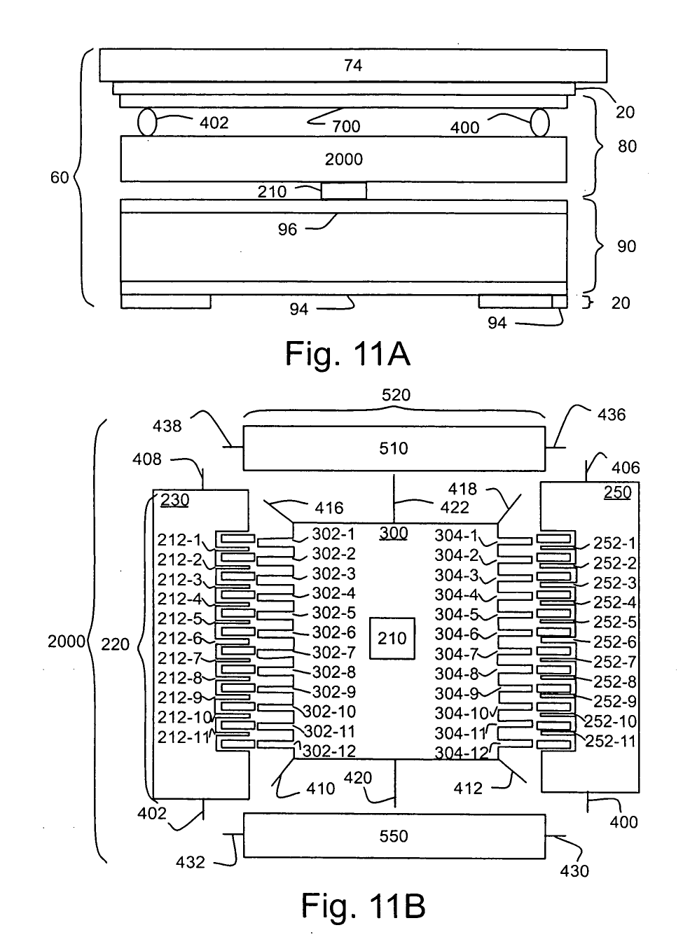

Examples of the invention using micro-actuator assemblies employing the electrostatic effect are shown in FIGS. 1A and 1B derived from the FIGS. of U. S. Pat. application Ser. No. 10/986,345, which is incorporated herein by reference. FIG. 11A shows a schematic side view of the micro-actuator assembly 80 coupling to the flexure finger 20 via a micro-actuator mounting plate 700. FIG. 11B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the amplified read signal ar0 and the write differential signal pair W0 of the read-write head 94 of the slider 90.

The bonding block 210 preferably electrically couples the read-write head 90 to the amplified read signal ar0 and write differential signal pair W0, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the rotating disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated U.S. Patent application.

The electrostatic micro-actuator assembly 2000 may further include a second micro-actuator 520 including a third stator 510 and a fourth stator 550. Both the third and the fourth stator electostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated U.S. Patent application. The second micro-actuator may also provide motion sensing, which may indicate collision with the rotating disk surface 120-1 being accessed.

The central movable section 300 not only positions the read-write head 10, but is the conduit for the amplified read signal ar0, the write differential signal pair W0 and in certain embodiments, the first slider power signal SP1 and the second slider power signal SP2. The electrical stimulus of the first micro-actuator 220 is provided through some of its springs.

The central movable section 300 may preferably to be at ground potential, and so does not need wires. The read differential signal signal pair r0, write differential signal pair w0 and slider power signals SP1 and SP2 traces may preferably be routed with flexible traces all the way to the load beam 74 as shown in FIG. 11A.

The invention includes the head gimbal assembly 60 containing the flexure finger 20 coupled with the slider 90 and further containing the read trace path rtp electrically coupled to the amplified read signal ar0, as shown in FIG. 4B. The head gimbal assembly operates as follows when read accessing the data 122, preferably organized as the track 122, on the rotating disk surface 120-1. The slider 90 reports the amplified read signal ar0 as the result of the read access. The flexure finger provides the read trace path rtp for the amplified read signal.

The slider 90 may further include a first slider power terminal SP1 and a second slider power terminal SP2, both electrically coupled to the amplifier 96 to collectively provide power to generate the amplified read signal ar0. The flexure finger 20 may further include a first power path SP1P electrically coupled to said first slider power terminal and/or a second power path SP2P electrically coupled to the second slider power terminal SP2, which are collectively used to provide electrical power to generate the amplified read signal.

The head gimbal assembly 60 may further include a micro-actuator assembly 80 mechanically coupling to the slider 90 to aid in positioning the slider to access the data 122 on the rotating disk surface 120-1. The micro-actuator assembly may further include a first micro-actuator power terminal 82P1 and a second micro-actuator power terminal 82P2. The head gimbal assembly may further include the first micro-actuator power terminal electrically coupled to the first power path SP1P and/or the second micro-actuator power terminal electrically coupled to the second power path SP2P. Operating the head gimbal assembly may further preferably include operating the micro-actuator assembly to aid in positioning the slider to read access the data on the rotating disk surface, which includes providing electrical power shared by the micro-actuator assembly and by the amplifier 96 to collectively position the slider and support the amplifier generating the amplified read signal ar0.

The flexure finger 20 may be coupled to the load beam 74 as shown in FIGS. 3B and 11A, which may further include the first power path SPIP electrically coupled to a metallic portion of the load beam. In certain embodiments, the metallic portion of the load beam may be essentially all of the load beam.

In further detail, the head gimbal assembly 60 includes a base plate 72 coupled through a hinge 70 to a load beam 74. Often the flexure finger 20 is coupled to the load beam and the micro-actuator assembly 80 and slider 90 are coupled through the flexure finger to the head gimbal assembly.

Manufacturing the invention's head gimbal assembly 60 includes coupling the flexure finger 20 to the invention's slider 90, which further includes electrically coupling the read trace path rtp with the amplified read signal ar0. The invention includes the manufacturing process and the head gimbal assembly as a product of the process. Manufacturing the head gimbal assembly may further include coupling the micro-actuator assembly 80 to the slider. Coupling the micro-actuator assembly to the slider may include electrically coupling the first micro-actuator power terminal 82P1 to the first slider power terminal SP1P and/or electrically coupling the second micro-actuator power terminal 82P2 to the second slider power terminal SP2P.

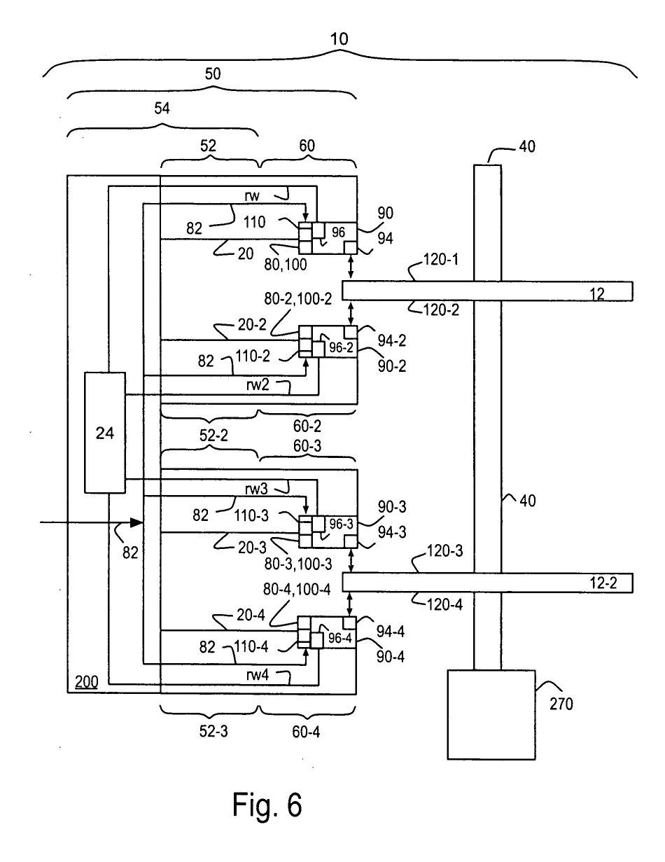

The invention also includes a head stack assembly 50 containing at least one head gimbal assembly 60 coupled to a head stack 54, as shown in FIGS. 5 and 6. The head stack assembly operates as follows when read accessing the data 122, preferably organized as the track 122, on the rotating disk surface 120-1. The slider 90 reports the amplified read signal ar0 as the result of the read access. The flexure finger provides the read trace path rtp for the amplified read signal, as shown in FIG. 4B. The main flex circuit 200 receives the amplified read signal from the read trace path to create the read signal 25-R.

The head stack assembly may include more than one head gimbal assembly coupled to the head stack. By way of example, FIG. 6 shows the head stack assembly coupled with a second head gimbal assembly 60-2, a third head gimbal assembly 60-3 and a fourth head gimbal assembly 60-4. Further, the head stack is shown in FIG. 5 including the actuator arm 52 coupling to the head gimbal assembly. In FIG. 6, the head stack further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second slider 90-2, which contains the second read-write head 94-2. The third head gimbal assembly includes the third slider 90-3, which contains the third read-write head 94-3. And the fourth head gimbal assembly includes a fourth slider 90-4, which contains the fourth read-write head 94-4.

The head stack assembly 50 may include a main flex circuit 200 coupled with the flexure finger 20, which may further include a preamplifier 24 electrically coupled to the read trace path rtp in the read-write signal bundle rw to create the read signal 25-R based upon the amplified read signal ar0 as a result of the read access to the track 122 on the rotating disk surface 120-1.

Manufacturing the invention's head stack assembly 50 includes coupling said at least one of the invention's head gimbal assembly 60 to the head stack 50 to at least partly create said head stack assembly. The manufacturing process may further include coupling more than one head gimbal assemblies to the head stack. The manufacturing may further, preferably include coupling the main flex circuit 200 to the flexure finger 20, which further includes electrically coupled the preamplifier 24 to the read trace path rtp to provide the read signal 25-R as a result of the read access of the data 122 on the rotating disk surface 120-1. The invention includes the manufacturing process for the head stack assembly and the head stack assembly as a product of the manufacturing process. The step coupling the head gimbal assembly 60 to the head stack 50 may further, preferably include swaging the base plate 72 to the actuator arm 52.

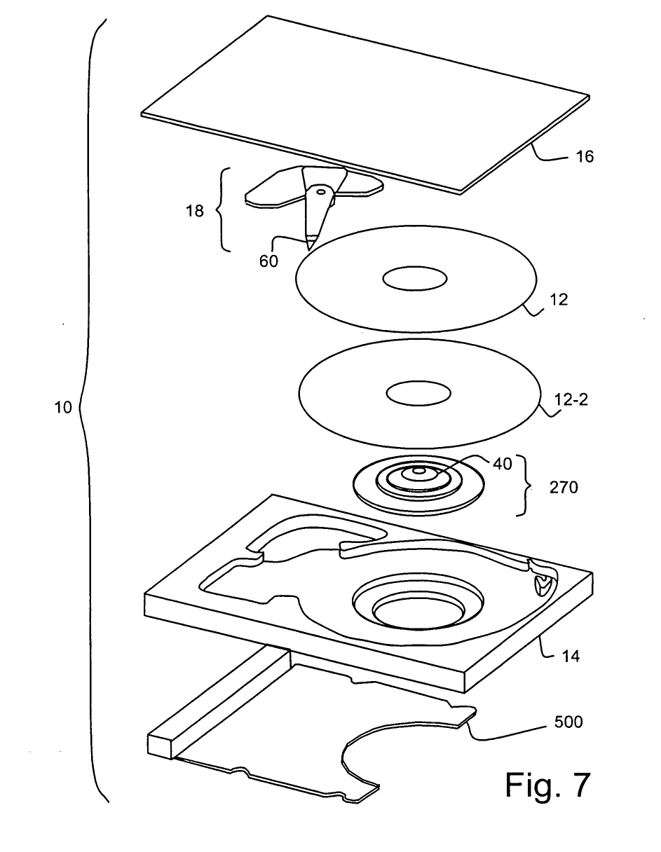

The invention includes a hard disk drive 10, shown in FIGS. 1A, 3A, 5, 6, and 7, to include the head stack assembly 50 electrically coupled to an embedded circuit 500 to process the read signal 25-R during the read access to the data 122, preferably organized as the track 122, on the rotating disk surface 120-1. The hard disk drive operates as follows when read accessing the data on the rotating disk surface. The slider 90 reports the amplified read signal ar0 as the result of the read access. The flexure finger provides the read trace path rtp for the amplified read signal, as shown in FIG. 4B. The main flex circuit 200 receives the amplified read signal from the read trace path to create the read signal 25-R. The embedded circuit receives the read signal to read the data on the rotating disk surface.

As stated before, the slider 90 reporting the amplified read signal may further include the read head 94-R driving the read differential signal pair r0 in reading the data 122 on the rotating disk surface 120-1 and the amplifier 96 receiving the read differential signal pair to generate the amplified read signal ar0.

In more detail, the hard disk drive 10 may include the servo controller 600, and possibly the embedded circuit 500, coupled to the voice coil motor 18, to provide the micro-actuator stimulus signal 650 driving the micro-actuator assembly 80, and the read signal 25-R based upon the amplified read signal ar0 contained in the read-write signal bundle rw from the read-write head 94 to generate the Position Error Signal 260.

The embedded circuit 500 may preferably include the servo controller 600, as shown in FIG. 5, including a servo computer 610 accessibly coupled 612 to a memory 620. A program system 1000 may direct the servo computer in implementing the method operating the hard disk drive 10. The program system preferably includes at least one program step residing in the memory. The embedded circuit may preferably be implemented with a printed circuit technology. The lateral control signal 82 may preferably be generated by a micro-actuator driver 28. The lateral control signal preferably includes the first lateral control signal 82P1 and the second lateral control signal 82P2, as well as the AC lateral control signal 82AC.

The voice coil driver 30 preferably stimulates the voice coil motor 18 through the voice coil 32 to provide coarse position of the slider 90, in particular, the read head 94-R near the track 122 on the rotating disk surface 120-1.

A computer as used herein may include at least one instruction processor and at least one data processor, where each of the data processors is directed by at least one of the instruction processors.

Manufacturing the hard disk drive 10 includes electrically coupling the invention's head stack assembly 50 to the embedded circuit 500 to provide the read signal 25-R as the result of the read access of the data 122 on the rotating disk surface 120-1. The invention includes this manufacturing process and the hard disk drive as a product of that process.

Making the hard disk drive 10 may further include coupling the servo controller 600 and/or the embedded circuit 500 to the voice coil motor 18 and providing the micro-actuator stimulus signal 650 to drive the micro-actuator assembly 80.

Making the servo controller 600 and/or the embedded circuit 500 may include programming the memory 620 with the program system 1000 to create the servo controller and/or the embedded circuit, preferably programming a non-volatile memory component of the memory.

Making the embedded circuit 500, and in some embodiments, the servo controller 600, may include installing the servo computer 610 and the memory 620 into the servo controller and programming the memory with the program system 1000 to create the servo controller and/or the embedded circuit.

Looking at some of the details of FIG. 6, the hard disk drive 10 includes a disk 12 and a second disk 12-2. The disk includes the rotating disk surface 120-1 and a second rotating disk surface 120-2. The second disk includes a third rotating disk surface 120-3 and a fourth rotating disk surface 120-4. The voice coil motor 18 includes an head stack assembly 50 pivoting through an actuator pivot 58 mounted on the disk base 14, in response to the voice coil 32 mounted on the head stack 54 interacting with the fixed magnet 34 mounted on the disk base. The actuator assembly includes the head stack with at least one actuator arm 52 coupling to a slider 90 containing the read-write head 94. The slider is coupled to the micro-actuator assembly 80.

The read-write head 94 interfaces through a preamplifier 24 on a main flex circuit 200 using a read-write signal bundle rw typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator assembly. It may be further preferred that the lateral control signal 82 be shared. Typically, each read-write head interfaces with the preamplifier using separate read and write signals, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

During normal disk access operations, the embedded circuit 500 and/or the servo controller 600 direct the spindle motor 270 to rotate the spindle shaft 40. This rotating is very stable, providing a nearly constant rotational rate through the spindle shaft to at least one disk 12 and sometimes more than one disk. The rotation of the disk creates the rotating disk surface 120-1, used to access the track 122 while accessing the track. These accesses normally provide for reading the track and/or writing the track.

The preceding embodiments provide examples of the invention and are not meant to constrain the scope of the following claims.

What is claimed is:

1. A slider, comprising:
a read-write head providing a read differential signal pair to an amplifier to generate an amplified read signal;
wherein said slider is used to access data on a rotating disk surface in a hard disk drive; and
wherein said slider reports said amplified read signal as a result of read access of said data on said rotating disk surface.

2. The slider of claim 1, wherein said read-write head, comprises:
a read head driving said read differential signal pair; and
a write head receiving said write differential signal pair;
wherein said slider receives said write differential signal pair to write access said data on said rotating disk surface.

3. The slider of claim 2, wherein said read head uses a member of the group consisting of a spin valve to drive said read differential signal pair; and a tunnel valve to drive said read differential signal pair.

4. The slider of claim 2, wherein said slider further comprises a vertical microactuator for adjusting the vertical distance between said read-write head and said rotating disk surface.

5. The slider of claim 1, wherein said amplified read signal implements a member of the group consisting of: a second read differential signal pair; and a single-ended read signal.

6. The slider of claim 1, wherein said slider, further comprises:
a first slider power terminal and a second of said slider power terminals collectively used to power said amplifier in generating said amplified read signal.

7. The slider of claim 1, further comprising: an air-bearing surface opposite said amplifier.

8. A flexure finger for said slider of claim 1, comprising: a read trace path for said amplified read signal.

9. The flexure finger of claim 8, further comprising: a micro-actuator assembly for mechanically coupling with said slider to aid in positioning said slider to access said data on said rotating disk surface.

10. The flexure finger of claim 9,
wherein said micro-actuator assembly aids in laterally positioning said slider to said rotating disk surface.

11. The flexure finger of claim 10,
wherein said micro-actuator assembly aids in vertically positioning said slider to said rotating disk surface.

12. The flexure finger of claim 9, wherein said micro-actuator assembly employs at least one member of the group consisting of a piezoelectric effect and an electrostatic effect, to position said slider to access said data on said rotating disk surface.

13. A head gimbal assembly, comprising: said flexure finger of claim 8 coupled with said slider, further comprising: said read trace path electrically coupled with said amplified read signal.

14. The head gimbal assembly of claim 13,
wherein said slider, further comprises: a first slider power terminal and a second slider power terminal, both electrically coupled to said amplifier to collectively provide power to generate said amplified read signal;
wherein said flexure finger, further comprises:
a first power path electrically coupled to said first slider power terminal; and
a second power path electrically coupled to said second slider power terminal;
wherein said first power path and said second power path are collectively used to provide electrical power for said amplifier to generate said amplified read signal.

15. The head gimbal assembly of claim 14, wherein said flexure finger, further comprises: a micro-actuator assembly mechanically coupling to said slider to aid in positioning said slider to access said data on said rotating disk surface.

16. The head gimbal assembly of claim 11, wherein said micro-actuator assembly, comprises: a first micro-actuator power terminal and a second micro-actuator power terminal;
wherein said head gimbal assembly, further comprises at least one member of the group consisting of:
said first micro-actuator power terminal electrically coupled to said first power path; and
said second micro-actuator power terminal electrically coupled to said second power path.

17. The head gimbal assembly of claim 16, comprises:
said first micro-actuator power terminal electrically coupled to said first power path; and
said second micro-actuator power terminal electrically coupled to said second power path.

18. The head gimbal assembly of claim 14, further comprising: said flexure finger coupled to a load beam.

19. The head gimbal assembly of claim 18, wherein said flexure finger coupled to said load beam, further comprises:
said first power path electrically coupled with a metallic portion of said load beam.

20. The head gimbal assembly of claim 19, wherein said metallic portion of said load beam is essentially all of said load beam.

21. A head stack assembly, comprising at least one of said head gimbal assemblies of claim 13, coupled to a head stack.

22. The head stack assembly of claim 21, further comprising at least two of said head gimbal assemblies coupled to said head stack.

23. The head stack assembly of claim 21, further comprising:
a main flex circuit coupled with said flexure finger, further comprising:
a preamplifier electrically coupled to said read trace path to create a read signal based upon said amplified read signal as a result of said read access to data on said rotating disk surface.

24. The hard disk drive, comprising said head stack assembly of claim 21 electrically coupled to an embedded circuit to process said read signal during said read access to said data on said rotating disk surface.

25. A method of operating said hard disk drive of claim 24, comprising the step:
read accessing said data on said rotating disk surface, comprising the steps:
said slider reporting said amplified read signal as said result of said read access to said data on said rotating disk surface;
said flexure finger providing said read trace path for said amplified read signal;
said main flex circuit receiving said amplified read signal from said read trace path to create said read signal; and
said embedded circuit receiving said read signal to read said data on said rotating disk surface.

26. The method of claim 25, wherein the step of said slider reporting, further comprising the steps:
said read head driving said read differential signal pair in reading said data on said rotating disk surface; and
said amplifier receiving said read differential signal pair to generate said amplified read signal.

27. A method of manufacturing said hard disk drive of claim 24, comprising the steps:
electrically coupling said head stack assembly to said embedded circuit to provide said read signal as said result of said read access to said data on said rotating disk surface to create said hard disk drive.

28. The hard disk drive as a product of the process of claim 27.

29. A method of operating said head stack assembly of claim 21, comprising the step:
read accessing said data on said rotating disk surface, comprising the steps:
said slider reporting said amplified read signal as said result of said read access to said data on said rotating disk surface;
said flexure finger providing said read trace path for said amplified read signal; and
said main flex circuit receiving said amplified read signal from said read trace path to create said read signal.

30. A method of manufacturing said head stack assembly of claim 21, comprising the step:
coupling said at least one of said head gimbal assemblies to said head stack to at least partly create said head stack assembly.

31. The method of claim 30, further comprising the step:
coupling a main flex circuit to said flexure finger, further comprising the step:
electrically coupling a preamplifier to said read trace path to provide a read signal based upon said amplified read signal as a result of said read access to data on said rotating disk surface.

32. The head stack assembly as a product of the process of claim 30.

33. A method of operating said head gimbal assembly of claim 13, comprising the step:
read accessing said data on said rotating disk surface, comprising the steps:
said slider reporting said amplified read signal as said result of said read access to said data on said rotating disk surface; and
said flexure finger providing said read trace path for said amplified read signal.

34. The method of claim 33, wherein said head gimbal assembly, further includes: a micro-actuator assembly mechanically coupled with said slider to aid in positioning said slider to access said data on said rotating disk surface;
wherein said method, further comprising the step:
operating said micro-actuator assembly to aid in positioning said slider to read access said data on said rotating disk surface, further comprising the step:
providing electrical power shared by said micro-actuator assembly and by said amplifier to collectively position said slider and support said amplifier.

35. A method of manufacturing said head gimbal assembly of claim 13, comprising the step:
coupling said flexure finger to said slider to at least partly create said head gimbal assembly, further comprising the step:
electrically coupling said read trace path to said amplified read signal.

36. The method of claim 35, further comprising the step:
coupling a micro-actuator assembly to said slider to at least partly create said head gimbal assembly.

37. The method of claim 36,
wherein said slider, further comprises: a first slider power terminal and a second slider power terminal, both electrically coupled to said amplifier to collectively provide power to generate said amplified read signal;
wherein said micro-actuator assembly, comprises: a first micro-actuator power terminal and a second micro-actuator power terminal;
wherein the step coupling said micro-actuator assembly to said slider, further comprises at least one member of the group consisting of the steps:
electrically coupling said first micro-actuator power terminal to said first slider power terminal; and
electrically coupling said second micro-actuator power terminal to said second slider power terminal.

38. The head gimbal assembly as a product of the process of claim 35.

39. A method of operating said slider of claim 2, comprising the step:
operating said slider to read access said data on said rotating disk surface, further comprising the steps:
said read head driving said read differential signal pair to read access said data on said rotating disk surface; and
said amplifier receiving said read differential signal pair to generate said amplified read signal.

40. A method of manufacturing said slider of claim 1, comprising the step:
coupling said read-write head to said amplifier to at least partly create said slider, further comprising the step:
electrically coupling said read differential signal pair to said amplifier.

41. The method of claim 40, further comprising the step:
providing an air bearing surface near said read head to at least partly create said slider.

42. The slider as a product of the process of claim 40.
